(19) United States
(12) Patent Application Publication
(10) Pub. No.: US 2005/0235832 A1
(43) Pub. Date: Oct. 27, 2005

(54) DUST VACUUM SYSTEM, AND METHODS OF CONSTRUCTING AND UTILIZING SAME

(76) Inventor: ALBIN L ANDERSON, RAPID RIVER, MI (US)

Correspondence Address: IRVING M. WEINER;WEINER & BURT, P.C., 635 N. US-23, P.O. BOX 186, HARRISVILLE, MI, 48740, US

(21) Appl. No.: 10/906,724

(22) Filed: Mar. 3, 2005

Related U.S. Application Data
(60) Provisional application No. 60/564,463, filed on Apr. 22, 2004.

(51) Int. Cl. B01D 47/02

(52) U.S. Cl. 96/351

(57) ABSTRACT

A dust/ash collection system which introduces the dust into water contained in a container. Above the water level there is provided a vacuum component.

The present patent application is a continuation-in-part of and claims priority from U.S. Provisional Patent Application Ser. No. 60/564,463 filed Apr. 22, 2004, the entire contents of which are incorporated herein by reference thereto.

The present invention relates generally to novel and unique dust vacuum systems, and methods of constructing and utilizing same.

More particularly, the present invention relates to novel and unique dust vacuum systems, and methods of constructing and utilizing same, wherein such systems vacuum up drywall dust or other fine dust, and prevent such dust from entering back into the ambient air.

### BACKGROUND OF THE INVENTION

The prior, but not necessarily relevant, art is exemplified by the following United States patents.

Hauge et al. U.S. Pat. No. 4,961,246, entitled AVACUUM CLEANING DEVICE@, discloses a vacuum cleaning device which includes a cleaning cart designed for use by janitorial service workers, wherein the cleaning cart includes a plurality of compartments formed in an open upper portion of a generally rectangular housing for storage of cleaning supplies and utensils.

Winters U.S. Pat. No. 5,263,225, entitled AWET/DRY VACUUM SYSTEM@, discloses vacuum means (wet or dry) system for collecting fluids and particular debris and wherein the system includes a collection tank, a removable cover providing a substantially air-tight connection with the tank, an air inlet and outlet apertures.

White et al. U.S. Pat. No. 6,175,988, entitled ABYPASS VACUUM CLEANER WITH FLEXIBLE VACUUM HOSE STORED OVER MOTOR COOLING AIR SHROUD AND CARRYING HANDLE,@ discloses an electric motor driven bypass type vacuum cleaner apparatus, particularly adapted for wet/dry debris collection including an open top debris collection tank having opposed integrally formed cup-shaped feet for supporting said apparatus in a stable position on a support surface.

It is a desiradatum of the present invention to avoid the animadversions of the previous techniques, devices, systems and mechanisms for vacuuming dust and other particular matter, and at the same time to provide novel and unique dust vacuum systems which are particularly useful for drywall repair situations and also for vacuuming ashes from fireplaces and furnaces.

### SUMMARY OF THE INVENTION

The present invention provides a dust or ash collection system, comprising: a container apparatus for holding a predetermined amount of water therein which divides said container apparatus into a water-holding portion and an air-holding portion disposed above said water-holding portion; cover means for covering said container apparatus and for separating said container apparatus from the ambient atmosphere; and dust/ash collection means operably interconnected with the container apparatus and for conveying the dust or ashes into said water in said container apparatus.

The present invention also provides a novel and unique dust vacuum system and device wherein there is provided a unique water tank apparatus interconnected between vacuum means (wet or dry) and the vacuum pickup hose.

One of the primary objects of the present invention is to provide novel and unique dust vacuum systems and methods of constructing and utilizing same, as described hereinabove, wherein the dust is prevented from going back into the ambient air.

It is another object of the present invention to provide novel and unique dust vacuum systems, and methods of constructing and utilizing same, as described hereinabove, wherein there is provided a novel water tank apparatus interposed between the vacuum pickup hose and vacuum means (wet or dry) system.

The present invention possesses many advantages and features which will become more apparent to those persons skilled in this particular area of technology and to other persons after having read the detailed description of some exemplary preferred embodiments of the present invention as set forth hereinbelow in conjunction with the accompanying patent drawings.

### BRIEF DESCRIPTION OF THE DRAWINGS

FIG. 1 illustrates, partly in section, a first preferred embodiment of the present invention.

FIG. 2 is a fragmentary perspective view of a portion of the pipe which is immersed in the water tank of FIG. 1.

FIG. 3 is a schematic illustration of a second preferred embodiment of the present invention.

FIG. 4 illustrates a schematic view of a third preferred embodiment in accordance with the present invention.

FIG. 5 shows a schematic view of a fourth preferred embodiment according to the present invention.

FIGS. 6, 7 and 9 illustrate modified alternatives for the open end portion of the dust/ash collection means where it enters into the water containing portions of FIGS. 1, 3, 4, or 5.

FIG. 8 illustrates a schematic view of a fifth preferred embodiment in accordance with the present invention.

### DETAILED DESCRIPTION OF SOME PREFERRED EMBODIMENTS

With reference to FIG. 1 of the drawings, the novel vacuum system 10 includes vacuum means (wet or dry) component 11, a dust pickup hose 12, and a water container apparatus 13 interposed between the wet/dry vacuum component 11 and the vacuum pickup hose 12.

Preferably, but not necessarily, the intermediate water retention receptacle 13 may be a metal trash can 14 with a lid 15 which has a capacity of 20 gallons or larger.

The tank 14 is provided with an elbow device 16 for connecting the wet/dry vacuum 11 to the tank 14. Preferably, but not necessarily, the elbow 16 points upwardly in the tank 14.

As shown in FIG. 1, the tank 14 is provided with a second elbow 17 for connecting the vacuum pickup hose 12 to the tank 14, and said elbow 17 is in communication with an L-shaped member 18, at least a portion of which is submersed in water 22 contained in the tank 14.

A portion of the L-shaped member 18 is provided with a pipe 19 having evenly-spaced apertures 20 therein. The apertured pipe 19 is closed by a cap or closure member 21.

In operation, the system of FIG. 1 operates when the wet/dry vacuum 11 is turned on, and the vacuum pickup hose 12 picks up dust and other debris. This dust and other debris is channeled into the submerged apertured pipe 19. In this manner, some of the dust and particular matter remains in the water 22, while some is sucked into the wet/dry vacuum 11. However, it is important to note that none of the dust is permitted to re-enter into the ambient air.

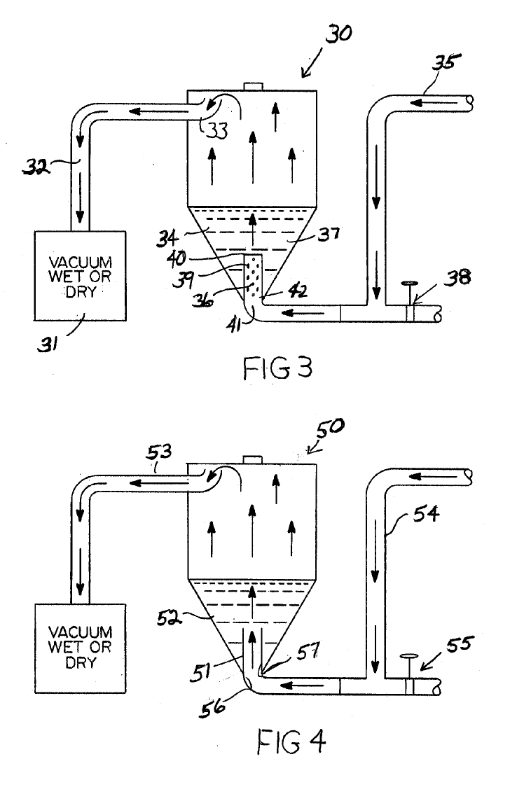

With reference to FIG. 3, there is shown a dust vacuum system 30 in accordance with a second preferred embodiment of the present invention.

The FIG. 3 system 30 includes vacuum means (wet or dry) 31 with a pipe or hose 32 connected to an elbow 33 in a tapered tank 34. The dust pickup pipe 35 communicates with a vertically-extending apertured dust pipe 36, which is submerged in water 37 in the tapered tank 34. There is also provided a shut-off and drain device 38.

It should be noted that in the FIG. 3 embodiment, the apertured pipe 36 with holes 39 is provided with a cap or closure member thereon 40, and there provided holes 41 and 42 to allow draining of sludge from the tank 34 when needed.

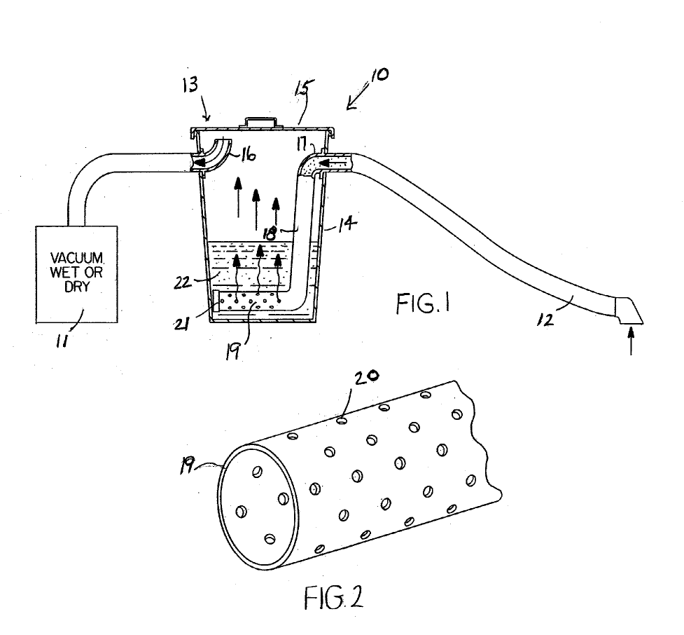

FIG. 2 illustrates an enlarged view of a fragmented portion of the pipe 19 or 36 having the apertures 20 or 39, respectively, therein, which can be used in the FIG. 1 or FIG. 3 embodiments. However, it should be noted that in FIG. 2, the apertured pipe 19 or 36 is shown without a cap thereon.

With reference to FIG. 4, there is shown a third preferred embodiment of the present invention which comprises a dust vacuum system 50 which is particular useful for vacuuming hot ash from wood stoves and the like.

The components of FIG. 4 are similar to the components in FIG. 3, however, the pipe 51 extending into the tapered water retention tank 52 in FIG. 4 is a solid pipe 51 with an open end.

Because the FIG. 4 system 50 is used for sucking hot ashes from wood stoves and the like, the pipes 51 and 54 therein should be preferably made from steel, and not plastic.

FIGS. 7 and 9 show a similar filter 75, but there is also included a reducer 76 which acts as a hood to create more agitation of the air and water and to force more dust or debris into the water.

There have been illustrated in the accompanying patent drawings and described hereinabove only several possible unique and novel preferred embodiments of the present invention which can be constructed in several different sizes and shapes.

It should be understood that many changes, modifications, variations, and other uses and applications of the present invention will become apparent to those persons skilled in this particular area of technology and to other persons after having been exposed to the present patent specification and accompanying patent drawings.

Any and all such changes, modifications, variations, and other uses and applications which do not depart from the spirit and scope of the present invention are therefor covered by and embraced within the present invention and patent application.

There are also provided holes 56 and 57 to allow draining of sludge from the tank 52 when needed.

With reference to the systems of FIGS. 3 and 4, preferably, but not necessarily, the tapered tank 34 or 52 can be mounted on a wall for permanent installation with the hoses and pipes connected to it.

Alternatively, the tapered tank 34 or 52 in the systems of FIGS. 3 and 4 can be mounted in a framework with wheels or casters installed onto the frame for easy movement.

The shut-off and drain device 38 or 55 shown in FIGS. 3 and 4 can be used to filter debris without shutting down the entire system and dumping.

Optionally, the pipe 19 in FIG. 1 can extend vertically into the tank 14.

The FIG. 5 system 60 includes vacuum means 61 (which may be wet or dry) with a pipe or hose 62 connected to the air-containing portion 63 of the container apparatus 64. A dust pickup pipe 65 communicates with a vertically-extending pipe 66 which extends into the water-containing portion 67 of the tapered tank 77. There is provided a shut-off and drain device 68.

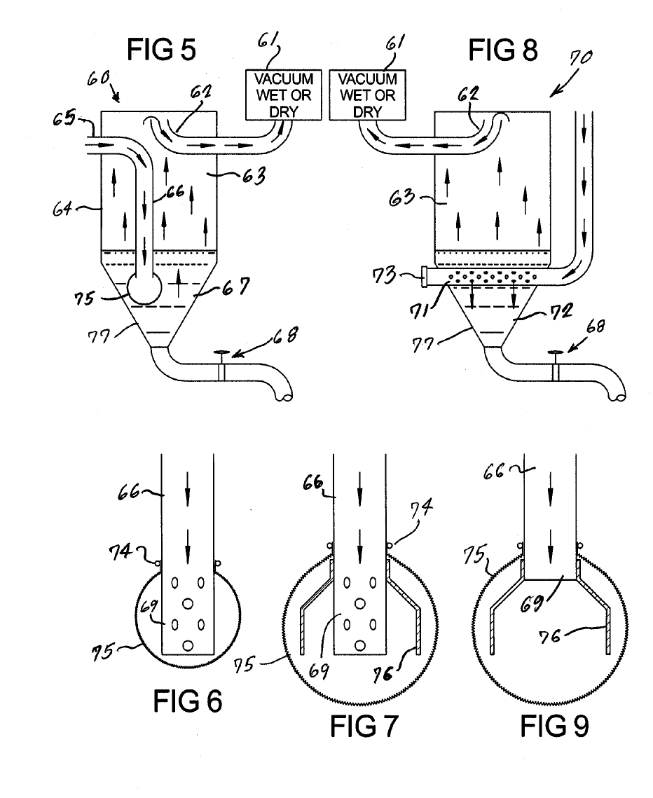

The open-ended portion 60 of a dust pickup pipe 65 may be perforated (as shown in FIG. 6 or 7) or solid (as shown in FIG. 9).

The FIG. 8 system 70 is similar to the FIG. 5 system 60, but the dust/ash collection means 71 is disposed substantially horizontally into the water-containing portion 72 and is terminated by a cap 73.

FIG. 6 shows the open-ended portion 69 of a dust collection pipe 66 which is surrounded by a filter 75 which is secured thereto by means of an O-ring 74 or a drawstring.

1. A dust or ash collection system, comprising:
a container apparatus for holding a predetermined amount of water therein which divides said container apparatus into a water-holding portion and an air-holding portion disposed above said water-holding portion;
cover means for covering said container apparatus and for separating said container apparatus from the ambient atmosphere; and
dust/ash collection means operably interconnected with the container apparatus and for conveying the dust or ashes into said water in said container apparatus.

2. The system according to claim 1, wherein:
said dust/ash collection means enters said container apparatus from the air-holding portion thereof, and extends down into said water-holding portion thereof.

3. The system according to claim 1, wherein:
said container apparatus has an upper substantially cylindrical portion and a lower portion which has a tapered shape.

4. The system according to claim 2, wherein:
said container apparatus has an upper substantially cylindrical portion and a lower portion which has a tapered shape.

5. The system according to claim 1, wherein:
at least a portion of said dust/ash collection means is perforated.

6. The system according to claim 2, wherein:
at least a portion of said dust/ash collection means is perforated.

7. The system according to claim 3, wherein:
at least a portion of said dust/ash collection means is perforated.

8. The system according to claim 4, wherein:
at least a portion of said dust/ash collection means is perforated.

9. The system according to claim 1, including:
a shut-off and drain device operably interconnected with said dust/ash collection means.

10. The system according to claim 2, including:
a shut-off and drain device operably interconnected with said dust/ash collection means.

11. The system according to claim 3, including:
a shut-off and drain device operably interconnected with said dust/ash collection means.

12. The system according to claim 4, including:
a shut-off and drain device operably interconnected with said dust/ash collection means.

13. The system according to claim 5, including:
a shut-off and drain device operably interconnected with said dust/ash collection means.

14. The system according to claim 6, including:
a shut-off and drain device operably interconnected with said dust/ash collection means.

15. The system according to claim 5, including:
a shut-off and drain device operably interconnected with said dust/ash collection means.

16. The system according to claim 8, including:
a shut-off and drain device operably interconnected with said dust/ash collection means.

17. The system according to claim 1, wherein:
said dust/ash collection means includes an open-ended portion disposed in said water in said container apparatus, and said open-ended portion is surrounded by filter means.

18. The system according to claim 17, wherein:
said open-ended portion of said dust/ash collection means is provided with a reducer which acts as a hood to create more agitation of the air and water and to force more dust or debris into the water.

19. The system according to claim 1, wherein:
said dust/ash collection means has a portion disposed substantially horizontally in said water-holding portion of said container apparatus.

20. The system according to claim 1, wherein:
said dust/ash collection means has a portion disposed substantially vertically in said water-holding portion of said container apparatus.
